(19) United States
(12) Patent Application Publication
(10) Pub. No.: US 2024/0328579 A1
(43) Pub. Date: Oct. 3, 2024

(54) NATURAL GAS STORAGE BATTERY AND METHODS

(71) Applicant: TIDEWATER MIDSTREAM AND INFRASTRUCTURE LTD., Calgary (CA)

(72) Inventors: Burwell Scott AYCOCK, Calgary (CA); Logan Taylor SPANGELO, Calgary (CA)

(21) Appl. No.: 18/311,211

(22) Filed: May 2, 2023

(30) Foreign Application Priority Data
Mar. 29, 2023 (CA) 3194529

(51) Int. Cl. F17C 5/06; F17C 1/00; F17C 3/00; F17C 13/00

(52) U.S. Cl. CPC F17C 5/06; F17C 1/007; F17C 3/005; F17C 13/002; F17C 13/004; F17C 2221/032; F17C 2223/033; F17C 2223/035; F17C 2225/033; F17C 2225/035; F17C 2250/0636; F17C 2265/07; F17C 2270/0581

(57) ABSTRACT

A natural gas energy storage system can comprise a high-pressure subterranean reservoir and a low-pressure subterranean reservoir. The high-pressure subterranean reservoir and the low-pressure subterranean reservoir can be configured to respectively receive and contain high-pressure natural gas and low-pressure natural gas. Said reservoirs can be coupled by a natural gas compression assembly and an energy recovery assembly to generate electricity. The natural gas compression assembly can be configured to recover natural gas from the low-pressure subterranean reservoir, compress the same to produce the high-pressure natural gas, and inject said gas into the high-pressure subterranean reservoir, during surplus periods. The energy recovery assembly can be configured to recover a portion of the high-pressure natural gas from the high-pressure subterranean reservoir, expand the same to generate energy and produce the low-pressure natural gas, and supply said gas into the low-pressure subterranean reservoir, during deficit periods.

### CROSS-REFERENCE TO RELATED APPLICATION

This application claims the benefit of Canadian Patent Application No. 3194529, filed on Mar. 29, 2023, which application is incorporated herein in its entirety.

### TECHNICAL FIELD

The technical field generally relates to gas and energy generation. More precisely, the technical field relates to natural gas storage and electricity production.

### BACKGROUND

Energy demand depends on various factors such as population, urbanization, and the technologies available to supply the electrical grid of a community. During warm and cold weather, the energy demand can leap and put a heavy pressure on existent electricity sources. Reducing energy demand remains an intricate challenge to address. Therefore, sustainable, and reliable auxiliary sources of energy must be found in accordance with landscape and natural resources available.

One existing option is underground natural gas storage. Underground natural gas storage is relatively common and was developed to mitigate seasonal fluctuations between production/transport capacities and consumption of natural gas. For example, natural gas can be injected in a reservoir, during summer or spring and be retrieved during winter. The storage capacity (in GW) of underground gas storage is extremely attractive when compared with batteries, pumped hydroelectric storage, or compressed air energy storage systems. However, the systems related to underground storage are mostly only used to meet seasonal demand for natural gas and do not exploit the potential energy contained in high-pressure gas to produce electricity.

There are indeed various challenges related to gas and energy storage and the present technology overcomes at least some of those challenges.

### SUMMARY

In accordance with an aspect, there is provided a natural gas energy storage system, comprising: a high-pressure subterranean reservoir configured to receive and contain high-pressure natural gas, the high-pressure subterranean reservoir being a first hydrocarbon-depleted subterranean reservoir; a low-pressure subterranean reservoir configured to receive and contain low-pressure natural gas, the low-pressure subterranean reservoir being a second hydrocarbon-depleted subterranean reservoir; a natural gas compression assembly configured to receive natural gas from the low-pressure subterranean reservoir, compress the natural gas to form the high-pressure natural gas, and supply the high-pressure natural gas into the high-pressure subterranean reservoir, during surplus periods; and an energy recovery assembly configured to receive at least a portion of the high-pressure natural gas from the high-pressure subterranean reservoir, expand the high-pressure natural gas to generate energy and produce the low-pressure natural gas, and supply the low-pressure natural gas into the low-pressure subterranean reservoir, during deficit periods.

In some implementations, the natural gas compression assembly comprises at least one compression stage configured to compress natural gas to form the high-pressure natural gas and inject the same into the high-pressure subterranean reservoir.

In some implementations, the natural gas compression assembly comprises at least one cooler downstream of each compression stage and configured to lower a temperature of the natural gas.

In some implementations, the natural gas energy storage system further comprises a gas-liquid separator located upstream of the energy recovery assembly and configured to separate free liquids from the high-pressure natural gas.

In some implementations, the gas-liquid separator comprises a flash drum.

In some implementations, the gas-liquid separator is configured to remove water and some liquid hydrocarbons as free liquids.

In some implementations, the energy recovery assembly comprises at least one gas expander and at least one generator configured to generate electricity when the high-pressure natural gas passes there through.

In some implementations, the energy recovery assembly comprises a multistage power generation assembly comprising a plurality of gas expanders each followed by a corresponding generator.

In some implementations, the natural gas energy storage system comprises a least one power storage battery configured to collect the electricity generated by the energy recovery assembly.

In some implementations, the electricity generated is directly supplied to an electrical grid.

In some implementations, the natural gas energy storage system comprises at least one heater configured to elevate a temperature of the high-pressure natural gas to form a heated high-pressure natural gas prior supplying into the at least one gas expander.

In some implementations, the heated high-pressure gas is provided at a temperature between 40° C. and 120° C.

In some implementations, the high-pressure subterranean reservoir and the low-pressure subterranean reservoir are naturally geologically contained.

In some implementations, the high-pressure subterranean reservoir is maintained at a pressure between 15,000 kPa and 45,000 kPa.

In some implementations, the low-pressure subterranean reservoir is maintained at a pressure between 1,000 kPa and 25,000 kPa.

In some implementations, the natural gas energy storage system further comprises a hydrocarbon recovery assembly configured to recover hydrocarbons from the natural gas retrieved from the low-pressure subterranean reservoir, from the natural gas retrieved from high-pressure subterranean reservoir, or alternating operation from one to the other.

In some implementations, the hydrocarbon recovery assembly is configured to receive a hydrocarbon-containing natural gas feed stream withdrawn from the low-pressure subterranean reservoir or withdrawn from the energy recovery assembly downstream the high-pressure subterranean reservoir.

In some implementations, the hydrocarbon recovery assembly is configured to receive the hydrocarbon-containing natural gas feed stream and produce at least one recovered liquid hydrocarbon-containing natural gas feed stream and a natural gas stream.

In some implementations, the at least one recovered hydrocarbon stream is a variation of C2, C3, C4, C5+ and/or sales quality component stream of C2 and heavier.

In some implementations, the hydrocarbon recovery assembly comprises a chiller configured to lower a temperature of the hydrocarbon-containing natural gas feed stream, followed by a separator that produces a gas overhead stream and a liquid stream.

In some implementations, the chiller is configured to lower the temperature of the hydrocarbon-containing natural gas feed stream to between 0° C. and 90° C.

In some implementations, the separator comprises a flash vessel.

In some implementations, the natural gas energy storage system further comprises a separation unit configured to receive the liquid stream and produce an upper gas stream and a bottom liquid stream.

In some implementations, the separation unit comprises of at least one distillation column.

In some implementations, the natural gas energy storage system further comprises a heater configured to heat the liquid stream prior to entry into the separation unit.

In some implementations, the natural gas energy storage system further comprises a heat exchanger for indirect heat exchange between the gas overhead stream and the hydrocarbon-containing natural gas feed stream.

In some implementations, the natural gas energy storage system further comprises a piping assembly configured to merge the upper gas stream of the separation unit with the gas overhead stream of the separator to form a combined natural gas stream.

In some implementations, the hydrocarbon-containing natural gas feed stream is from the low-pressure subterranean reservoir, the natural gas compression assembly is in fluid communication with the piping assembly to receive the combined natural gas stream.

In some implementations, the hydrocarbon-containing natural gas feed stream is from the energy recovery assembly, the low-pressure subterranean reservoir is in fluid communication with the piping assembly to receive the combined natural gas stream.

In some implementations, the hydrocarbon recovery assembly is part of a shallow cut gas plant.

In some implementations, the natural gas energy storage system further comprises an additional separation unit configured to receive the gas overhead stream and produce an additional overhead stream and an additional liquid stream.

In some implementations, the natural gas energy storage system further comprises an overhead expander for receiving the gas overhead stream and producing an expanded stream that is fed to the additional separation unit.

In some implementations, the natural gas energy storage further comprises a piping arrangement configured to merge the liquid stream and the additional liquid stream to form a combined liquid stream, and wherein the separation unit is in fluid communication with the piping arrangement to receive the combined liquid stream.

In some implementations, the natural gas energy storage further comprises a piping assembly configured to merge the upper gas stream of the separation unit with the additional overhead stream of the additional separation unit to form a combined natural gas stream.

In some implementations, when the hydrocarbon-containing natural gas feed stream is from the low-pressure subterranean reservoir, the natural gas compression assembly is in fluid communication with the piping assembly to receive the combined natural gas stream.

In some implementations, when the hydrocarbon-containing natural gas feed stream is from the energy recovery assembly, the low-pressure subterranean reservoir is in fluid communication with piping assembly to receive the combined natural gas stream.

In some implementations, the additional separation unit is a de-methanizer.

In some implementations, the hydrocarbon recovery assembly is part of a deep cut gas plant.

In some implementations, the at least one distillation column of the separation unit is selected from a group composed of a de-methanizer, a de-ethanizer, a de-propanizer, a de-butanizer and a stabilizer.

In some implementations, the at least one distillation column is a stabilizer, the stabilizer is configured to treat the bottom liquid stream by flash separation to produce a C2 to C4 hydrocarbon gas stream and a C5+ hydrocarbon liquid stream.

In some implementations, the high-pressure subterranean reservoir is maintained at a temperature between 40 and 120° C.

In some implementations, the low-pressure subterranean reservoir is maintained at a temperature between 40 and 120° C.

In some implementations, the high-pressure subterranean reservoir and the low-pressure subterranean reservoir contain residual heavy hydrocarbons.

In some implementations, the same hydrocarbon recovery assembly is used for recovering hydrocarbons from the natural gas retrieved from the low-pressure subterranean reservoir and from the natural gas retrieved from high-pressure subterranean reservoir.

In some implementations, the hydrocarbon recovery assembly comprises one or more separation assemblies for removing hydrocarbons from the natural gas.

In some implementations, the separation assembly comprises a de-ethanizer.

In some implementations, the separation assembly comprises a multiple separation units.

In some implementations, the multiple separation units comprise at least one flash unit and at least one distillation unit.

In some implementations, the natural gas energy storage system further comprises a manually activated switch mechanism is configured to regulate gas transfer between the surplus period and the deficit period.

In some implementations, the natural gas energy storage system further comprises at least one holding tank.

In some implementations, the natural gas energy further comprises a booster downstream of at least one of the separation unit and the additional separation unit configured to adjust pressure of at least one of the upper gas stream and the additional overhead stream.

According to another aspect, there is provided a process of storing energy and natural gas, the process comprising: a compression stage operated during surplus periods, the compression stage comprising: recovering low-pressure natural gas from a low-pressure subterranean reservoir; compressing natural gas at surface to produce a high-pressure natural gas; supplying the high-pressure natural gas into a first hydrocarbon-depleted subterranean reservoir as a high-pressure subterranean reservoir; an energy recovery stage operated during deficit periods, the energy recovery stage comprising: recovering at least a portion of the high-pressure natural gas from the high-pressure subterranean reservoir; expanding the high-pressure natural gas at surface to generate energy and low-pressure natural gas; and supplying the low-pressure natural gas into a second hydrocarbon-depleted subterranean reservoir as the low-pressure subterranean reservoir.

In some implementations of the process, compressing the natural gas comprises at least one compression stage and at least one cooling step downstream of each of the at least one compression stage.

In some implementations of the process, compressing the natural gas comprises recovering thermal energy retrieved by the at least one cooling step.

In some implementations of the process, expanding the high-pressure natural gas is performed using at least one gas expander-and-generator assembly and at least one heat exchanger to form the low-pressure natural gas and to generate electricity.

In some implementations of the process, the electricity generated is stored in a battery or supplied directly to an energy grid.

In some implementations of the process, the low-pressure natural gas is transferred to a sales line once a determined residence time is over.

In some implementations of the process, transferring the low-pressure natural gas is performed at a pressure between 4000 and 7000 kPa.

In some implementations of the process, the process further comprises recovering hydrocarbons from the low-pressure natural gas at surface.

In some implementations of the process, recovering of the hydrocarbons comprises subjecting the natural gas to a first separation stage to produce a gas overhead stream and a liquid stream, subjecting the liquid stream to a second separation stage to produce an upper gas stream and a bottom liquid stream, and combining the upper gas stream and the gas overhead stream to produce a combined natural gas stream.

In some implementations of the process, recovering of the hydrocarbons comprises subjecting the natural gas to a first separation stage to produce a gas overhead stream and a liquid stream, subjecting the gas overhead stream to an additional separation stage to produce an additional overhead stream and an additional liquid stream, combining the additional liquid stream with the liquid stream to produce a combined liquid stream, subjecting the combined liquid stream to a second separation stage to produce an upper gas stream and a bottom liquid stream, and combining the upper gas stream and the additional overhead stream to produce a combined natural gas stream.

In some implementations of the process, during the compression stage, the combined natural gas stream is supplied as the natural gas for compression at surface to produce the high-pressure natural gas.

In some implementations of the process, during the energy recovery stage, the combined natural gas stream is supplied as the low-pressure natural gas to the low-pressure subterranean reservoir.

In some implementations of the process, the first separation stage is a flash separation.

In some implementations of the process, the second separation stage is a de-ethanization stage.

In some implementations of the process, the additional separation stage is a de-methanization stage.

In some implementations of the process, recovering hydrocarbons is performed using a deep cut gas plant.

In some implementations of the process, recovering hydrocarbons is performed using a shallow cut gas plant.

In some implementations of the process, the energy recovery stage is performed with multiple expanders and generators arranged in series.

In some implementations of the process, the compression stage is performed with multiple compressors arranged in series.

In some implementations of the process, the high-pressure subterranean reservoir and the low-pressure subterranean reservoir are mature hydrocarbon-depleted subterranean reservoirs used for recovery of natural gas liquids, oil, or a combination thereof.

According to another aspect, there is provide a use of first and second hydrocarbon-depleted subterranean reservoirs for natural gas and energy storage, wherein the first hydrocarbon-depleted subterranean reservoir is operated as a high-pressure subterranean reservoir receiving and storing high-pressure natural gas during surplus periods and the second hydrocarbon-depleted subterranean reservoir is operated as a low-pressure subterranean reservoir receiving and storing low-pressure natural gas produced by energy-generating expansion of at least a portion of the high-pressure natural gas during deficit periods.

According to another aspect, there is provided a natural gas energy storage system, comprising: a high-pressure subterranean reservoir configured to receive and contain high-pressure natural gas, the high-pressure subterranean reservoir being a hydrocarbon-depleted subterranean reservoir; a natural gas compression assembly configured to receive natural gas from a natural gas source, compress the natural gas to form the high-pressure natural gas, and supply the high-pressure natural gas into the high-pressure subterranean reservoir, during surplus periods; an energy recovery assembly configured to receive at least a portion of the high-pressure natural gas from the high-pressure subterranean reservoir, expand the high-pressure natural gas to generate energy and produce low-pressure natural gas, and supply the low-pressure natural gas to the low-pressure natural gas source, during deficit periods; a hydrocarbon recovery assembly configured to recover at least C4+ hydrocarbons and/or non-hydrocarbon components from the low-pressure natural gas produced by the energy recovery assembly and produce a hydrocarbon-lean gas stream and a recovered hydrocarbon stream; and a return line configured to supply the hydrocarbon-lean gas stream back to the natural gas source.

In some implementations, the recovered hydrocarbon stream is composed of any variation of C2, C3, C4 or C5+ and/or sales quality component streams of C2 and heavier.

In some implementations, the hydrocarbon recovery assembly is configured to produce a hydrocarbon lean gas stream comprising C2 and C3 hydrocarbons.

In some implementations, the natural gas compression assembly is configured to receive the hydrocarbon lean gas stream comprising C2 and C3 hydrocarbons to produce the high-pressure natural gas.

In some implementations, the natural gas source comprises a natural gas pipeline.

In some implementations, the natural gas source comprises a low-pressure subterranean reservoir.

According to a further aspect, there is provided a process of storing energy and natural gas, the process comprising: a compression stage operated during surplus periods, the compression stage comprising: recovering low-pressure natural gas from a natural gas source; compressing natural gas at surface to produce a high-pressure natural gas; supplying the high-pressure natural gas into a hydrocarbon-depleted subterranean reservoir as a high-pressure subterranean reservoir; an energy recovery stage operated during deficit periods, the energy recovery stage comprising: recovering at least a portion of the high-pressure natural gas from the high-pressure subterranean reservoir; and expanding the high-pressure natural gas at surface to generate energy and low-pressure natural gas; a hydrocarbon recovery assembly configured to recover hydrocarbons from the low-pressure natural gas produced by the energy recovery assembly and produce a hydrocarbon-lean gas stream and a recovered hydrocarbon; and supplying the hydrocarbon-lean gas stream back to the natural gas source.

In some implementations of the process, the recovered hydrocarbon stream is composed of any a variation of C2, C3, C4, C5+ and/or sales quality component stream of C2 and heavier.

In some implementations of the process, the natural gas source comprises a natural gas pipeline.

In some implementations of the process, the natural gas source comprises a low-pressure subterranean reservoir.

### BRIEF DESCRIPTION OF THE DRAWINGS

The attached figures illustrate various features, aspects and implementations of the technology described herein.

FIG. 1 is a schematic of an example implementation of the system.

FIG. 2 is a schematic of an example implementation of part of the system.

FIG. 3 is a schematic of an example implementation of part of the system.

FIGS. 4A and 4B are schematics of an example implementation of part of the system respectively showing two operating modes.

FIG. 5 is a schematic of an example implementation of part of the system.

### DETAILED DESCRIPTION

Techniques described herein relate to systems and processes for natural gas and energy storage. Example implementations will be described in detail below.

A natural gas energy storage system can comprise two underground reservoirs, a high-pressure subterranean reservoir and a low-pressure subterranean reservoir kept at determined pressures, in communication via a natural gas compression assembly and an energy recovery assembly. Natural gas can therefore be transferred back and forth between the two reservoirs using the assemblies depending on electricity demand and energy market conditions.

### Overall System Example

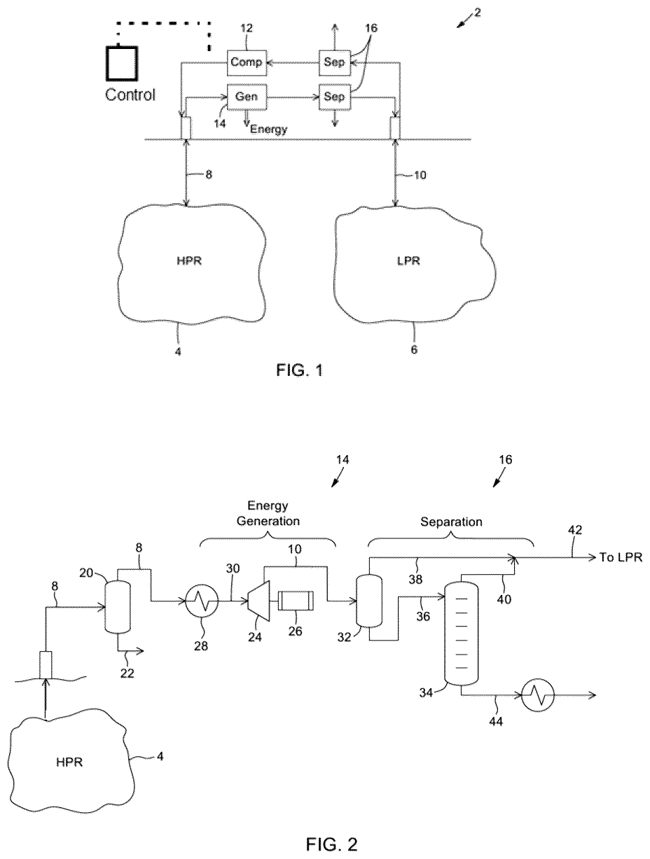

Referring to FIG. 1, a natural gas energy storage system 2 can comprise two reservoirs: a high-pressure subterranean reservoir 4 and a low-pressure subterranean reservoir 6. The high-pressure subterranean reservoir 4 can be configured to receive and contain high-pressure natural gas 8 and can be seen as a first hydrocarbon-depleted subterranean reservoir. The low-pressure subterranean reservoir 6 can be configured to receive and contain low-pressure natural gas 10 and can be seen as a second hydrocarbon-depleted subterranean reservoir. The reservoirs 4 and 6 can be coupled via a natural gas compression assembly 12 and an energy recovery assembly 14 to generate electricity. The natural gas compression assembly 12 can be configured to recover at least a portion of the low-pressure natural gas 10 from the low-pressure subterranean reservoir 6, compress the natural gas 10 above ground to produce the high-pressure natural gas 8 and supply the high-pressure natural gas 8 into the high-pressure subterranean reservoir 4, during surplus periods when considering a supply-demand balance of an energy market. A surplus period can be generally considered as a period during which the energy supply exceeds the energy demand. The energy recovery assembly 14 can be configured to recover at least a portion of the high-pressure natural gas 8 from the high-pressure subterranean reservoir 4, expand the high-pressure natural gas 8 to generate energy and produce the low-pressure natural gas 10, and supply the low-pressure natural gas 10 into the low-pressure subterranean reservoir 6, during deficit periods. A deficit period can thus be generally considered as a period during which the energy supply does not meet the energy demand. The system 2 can further comprise a hydrocarbon recovery assembly 16. The hydrocarbon recovery assembly 16 can be configured to recover hydrocarbons 18 and other components from the natural gas that is retrieved from one of the reservoirs. The hydrocarbon recovery assembly 16 can treat natural gas exiting the energy recovery assembly 14 and/or the low-pressure natural gas 10 prior injection into the natural gas compression assembly 12. The same assembly or distinct assemblies can be used for treating natural gas exiting the energy recovery assembly 14 or the low-pressure natural gas 10. It is noted that surplus and deficit periods can be defined in various ways depending on the overall setup and dynamics of power generation in the region of interest as well as other engineering and market factors. Fore example, it is possible for the natural gas energy storage system 2 to operate in an energy-generating mode even when the overall energy supply meets demand if the economic conditions are such that profitable sale of the energy or its above-ground storage (e.g., in a battery) are possible. Similarly, it is possible for the natural gas energy storage system 2 to operated in storage/compression mode even during periods of energy deficit, if desired. It is noted that the system can be operated such that energy-generating mode is used during relatively high deficit periods to optimize energy sale to the grid, and storage/compression mode is used during relatively high supply periods. For example, the energy-generating mode can be used within “peak load” periods and optionally “intermediate load” periods, while compression mode is used during “base load” periods. The modes can also be selected not only based on the electricity supply-demand balance, but also on market factors related to hydrocarbon recovery from the reservoirs (e.g., price of hydrocarbon liquids) and related to natural gas.

### Energy Recovery Assembly Implementations

Once the high-pressure natural gas 8 is produced by the natural gas compression assembly 12, electricity can be generated from the natural gas via the energy recovery assembly 14. The electricity can be generated by various systems and processes depending on the overall design and parameters for the implementation.

Referring to FIG. 2, a gas-liquid separator 20 can be located upstream of the energy recovery assembly 14 and can be configured to separate free liquids 22 from the high-pressure natural gas 8. The gas-liquid separator 20 can be, for example, a scrubber, a flash drum, or a filter separator. Any other suitable equipment can be used to separate the free liquids 22 from the high-pressure natural gas 8. The energy recovery assembly 14 can comprise at least one gas expander 24 and at least one generator 26 configured to generate electricity and produce the low-pressure natural gas 10 when the high-pressure natural gas 8 passes therethrough. Expansion of the high-pressure natural gas 8 via the gas expander 24 can significatively lower pressure as well as temperature of the high-pressure natural gas 8. The energy recovery assembly 14 can thus comprise at least one heater 28 configured to elevate the temperature of the high-pressure natural gas 8 to form a heated high-pressure natural gas 30 prior supplying that stream into a subsequent expander. The energy recovery assembly 14 can include multiple expander-generator pairs that are arranged in series and/or in parallel. For example, there may be 3, 4, 5 or more expander-generator pairs arranged in series. The number of expander-generator pairs can notably depend on the energy market conditions among other factors. This number can indeed be chosen to optimize the ability of the system to supply electricity to the grid during deficit periods. For example, deficit periods can be related to high energy peak periods, during summer and winter seasons for instance. Moreover, availability of other power sources on the market, such as wind power or solar power, can create fluctuations in the energy supply thus influencing the equipment for the energy recovery assembly 14. For example, if the grid has a notable component from wind power sources, then during low-wind periods the grid may enter a deficit period and thus energy from the natural gas battery system can be generated and supplied to the grid. As mentioned above, the energy recovery assembly 14 can be followed by the hydrocarbon recovery assembly 16. Further details regarding said assembly 16 are described in the section entitled Hydrocarbon recovery assembly implementations further below.

Regarding separation of free liquids, it is noted that a quantity of free liquids 22 can still remain in the high-pressure natural gas after separation in the gas-liquid separator 20. The free liquids 22 can comprise liquid hydrocarbons, such as C5+ hydrocarbons, and water depending on the contents and conditions of high-pressure subterranean reservoir 4 and low-pressure subterranean reservoir 6. In some implementations, when natural gas from a pipeline is introduced into the system for start-up, it is not required to treat the gas using the gas-liquid separator 20 since this pipeline natural gas typically contains no or low quantities of free liquids.

The at least one heater 28 can prevent condensation of the remaining free liquids in the high-pressure natural gas; condensed free liquids can cause early wear of the gas expander 24 and generator 26. The heated high-pressure natural gas 30 can be provided to the gas expander 24 at a temperature between 40° C. and 120° C. or at a temperature preventing significant condensation of free liquids across the expander. It is noted that in a scenario where the temperature of the high-pressure natural gas 8 is hot enough (e.g., between 40° C. and 120° C.) when exiting the high-pressure subterranean reservoir 4, no heater is necessary for preventing condensation. Thermal energy retrieved by at least one cooler that is part of the natural gas compression assembly 14 can be used to heat the high-pressure natural gas 8. In some implementations, the at least one heater 28 can be located upstream of the at least one gas expander 24 or downstream of the at least one generator 26. Various types and arrangements of heaters and coolers can be used in the system to enhance energy recycling and efficiency.

As noted above, the energy recovery assembly 14 can comprise a multistage power generation assembly comprising a plurality of gas expanders each coupled to a corresponding generator. The plurality of gas expanders can be expansion turbines using a pressure drop of the high-pressure natural gas to rotate and spin the corresponding generators therefore producing electricity.

In some implementations, the energy recovery assembly 14 can comprise at least one power storage battery configured to collect the electricity generated by the energy recovery assembly 14 in order to provide more flexibility and supply electricity when needed. The power capacity of the at least one power storage battery can be between 0.75 MW and 30 MW. In some implementations, the power capacity can range between 5 MW and 10 MW. In other scenarios, the electricity generated can be directly supplied to an electrical grid and/or directly for use at a dedicated facility.

The low-pressure natural gas 10 can be transferred to a sales line once a determined residence time within the system is over. This residence time can be based on natural gas pricing or contracted volumes of natural gas to be delivered after storage. The residence time could also be based on recoverable hydrocarbons present in the reservoirs 4 and 6, e.g., once the residual hydrocarbons are sufficiently depleted using the hydrocarbon recovery assembly 16 natural gas can be returned to the pipeline. The natural gas can be pre-treated before being supplied back to the sales line to meet specifications, which may include removing free liquids and any contaminants picked up from the reservoirs. The natural gas can be supplied to the sales line at a pressure between 4000 kPa and 7000 kPa, for example.

### Natural Gas Compression Assembly Implementation

In order to form the high-pressure natural gas 8, the low-pressure subterranean reservoir 6 and the high-pressure subterranean reservoir 4 can be connected via the natural gas compression assembly 12 acting as a compression stage. The natural gas compression assembly 12 can be located at ground level (i.e., at surface) and can be connected to the high-pressure subterranean reservoir 4 and the low-pressure subterranean reservoir 6 by piping and pumping equipment resistant to corrosion, high pressures, and high temperatures.

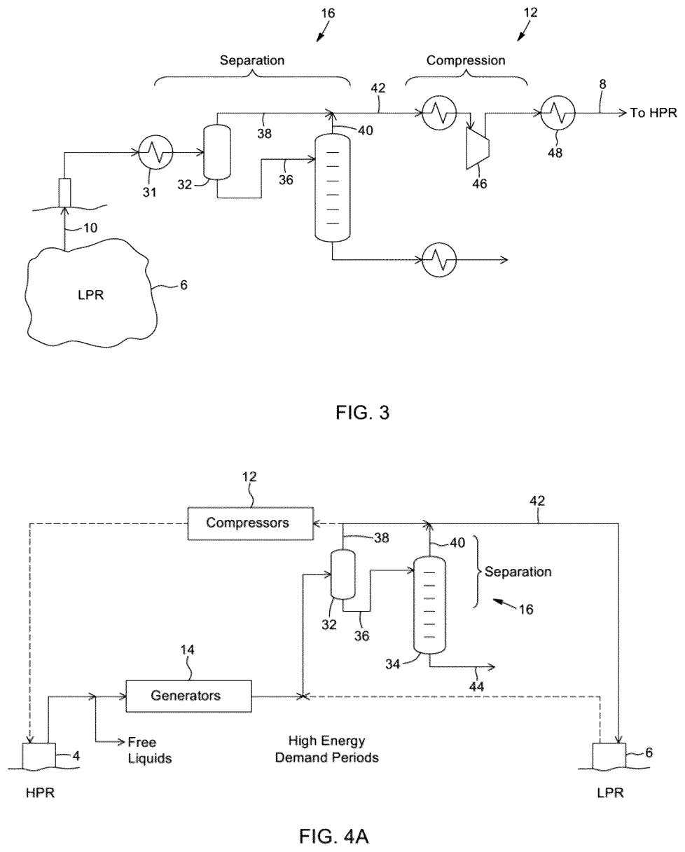

Referring to FIG. 3, the natural gas compression assembly 12 can comprise at least one compression stage 46 configured to compress the low-pressure natural gas 10 retrieved from the low-pressure subterranean reservoir 6 to form the high-pressure natural gas 8 and inject the pressurized gas 8 into the high-pressure subterranean reservoir 4. The temperature of the natural gas can increase between the at least one compression stage 46 depending on the type of compression, and the speed at which the low-pressure gas 10 is compressed. In order to lower the temperature of the natural gas, at least one cooler 48 can be located downstream of each of the at least one compression stage 46. Prior to compression, the low-pressure natural gas 10 can be treated using the hydrocarbon recovery assembly 16 to separate hydrocarbons from the natural gas. More details regarding the hydrocarbon recovery assembly 16 are disclosed in the section named Hydrocarbon recovery assembly implementations further below.

In some implementations, the thermal energy retrieved by the at least one cooler 48 can be stored in a thermal energy storage unit. For example, a potential medium for the thermal energy storage unit can be molten salt. Usable molten salts can include nitrates, chlorides, fluorides, and carbonates, for example. The thermal energy that is recovered can therefore be saved for later use, in indirect heat exchangers for instance. In view of optimizing energy efficiency, the retrieved thermal energy can also be used to evaporate a process fluid, such as water or a more volatile fluid, in a system exploiting a Rankine cycle.

Compression can be performed by using multiple compressors arranged in series. Various types of compressors can be used in the natural gas compression assembly 12 and the compressors can be different or the same. Suitable compressors include reciprocating compressors, displacement compressors, centrifugal compressor or screw compressors depending on operational conditions targeted. For example, the compressors can be selected based on the volume of natural gas to be treated or the output pressure desired.

### Operational Implementations

The natural gas energy storage system 2 can operate under different modes depending on energy supply and demand. When the energy supply is in surplus, meaning the supply exceeds the demand of the market, the low-pressure natural gas can be withdrawn and compressed by the natural gas compression assembly 12, which assembly 12 could be powered by sustainable energy sources such as wind power or solar energy. When energy supply is in deficit, meaning the supply does not meet the demand of the market, the high-pressure natural gas 8 can be withdrawn from the high-pressure subterranean reservoir 4 and injected into the energy recovery assembly 14 to produce electricity which is then sold or used. For a given system that includes two reservoirs, the two different modes cannot be operated simultaneously. A third mode can be considered as a static or holding mode where the natural gas is simply held in one of the reservoirs without withdrawal or processing by the compression 12 or energy-recovery 14 assemblies. The holding mode can be performed for a certain time period based on various factors, e.g., when energy availability is within an intermediate zone and thus could be considered neither in deficit nor in surplus and/or when it is desired for the natural gas to soak within the reservoir for hydrocarbon recovery purposes. A deficit in energy supply can be a signal for the system 2 to produce electricity via the energy recovery-assembly 14; and an energy surplus can be a signal for the system to compress natural gas through the natural gas compression assembly 12. The system 2 can be designed to follow a general maximum energy deficit of the market in the area where the system 2 is implemented. When power storage is included, the at least one power storage battery can be used to store electricity that can be supplied to the grid during deficit periods, for example when a regular electricity provider shuts down. The system's operation can also rely on prices of electricity, natural gas and/or NGL. For instance, when the selling price of natural gas is high, natural gas can be retrieved from the system 2 to be sold.

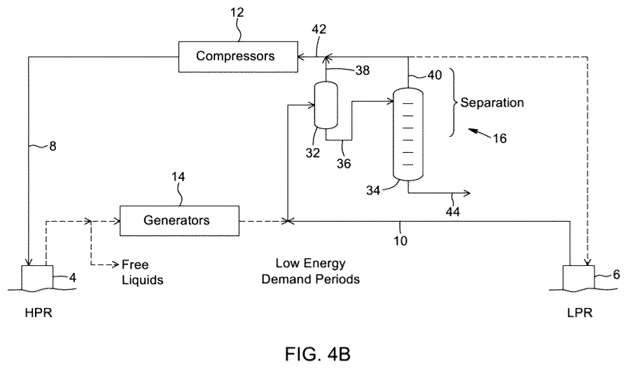

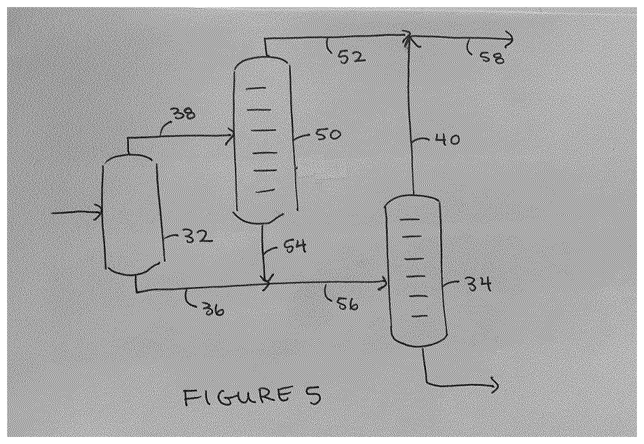

Referring to FIG. 4A, during deficit periods, the high-pressure natural gas 8 contained in the high-pressure subterranean reservoir 4 can be withdrawn and sent to the energy recovery assembly 14 in order to generate electricity and produce the low-pressure natural gas 10. The low-pressure natural gas 10 exiting that assembly 14 can then be treated by the hydrocarbon recovery assembly 16. The resulting low-pressure natural gas 10 can ultimately be injected into the low-pressure natural gas subterranean reservoir 6.

Alternatively, when considering the system of FIG. 4B, during surplus periods the low-pressure natural gas 10 can be converted into the high-pressure natural gas 8 by using the natural gas compression assembly 12. Before entering the natural gas compression assembly 12, the low-pressure natural gas 10 can be treated by the hydrocarbon recovery assembly 16 to separate hydrocarbons 18 from the natural gas. The high-pressure natural gas 8 exiting the natural gas compression assembly 12 can then be injected into the high-pressure subterranean reservoir 4.

### Reservoirs Implementations

The high-pressure subterranean reservoir 4 and the low-pressure subterranean reservoir 6 can be depleted reservoirs that previously contained hydrocarbons such as oil, gas, heavy oil, or bitumen in addition to water and other native components. The reservoirs may have been depleted using various in situ recovery methods. The high-pressure subterranean reservoir and the low-pressure subterranean reservoir can also be natural aquifers or salt cavern formations.

A natural aquifer can be converted as a natural gas reservoir when natural gas is injected at high pressures into the natural aquifer. The natural aquifer can include an impermeable rock overlay serving as containment and water. Salt caverns for storage can be constructed by leaching a salt dome to dissolve salt and removing the dissolved salt. Natural gas can then be injected into the cavern. One advantage of using depleted hydrocarbon reservoirs is that there is no need for heavy site preparation and that they are generally widely available depending on location, as opposed to natural aquifers and salt caverns. Another advantage of using depleted hydrocarbon reservoirs is that residual hydrocarbons can be recovered using the natural gas.

The high-pressure subterranean reservoir 4 and the low-pressure subterranean reservoir 6 can be naturally geologically contained. The subterranean reservoirs 4 and 6 can be selected based on sedimentary rock quality (e.g., porosity and permeability) required to extract and inject natural gas out and into the subterranean reservoirs 4 and 6. Suitable classes of sedimentary rocks can include carbonate and sandstone. The reservoirs can be located near a consumption region of natural gas and close to transportation infrastructure such as natural gas pipelines.

The high-pressure subterranean reservoir 4 can be maintained at a pressure between 15,000 kPa and 45,000 kPa and the low-pressure subterranean reservoir 6 can be maintained at a pressure between 1,000 kPa and 25,000 kPa. The high-pressure subterranean reservoir 4 and the low-pressure subterranean reservoir 6 can experience pressure swings while natural gas is transferred from one reservoir to the other. The reservoirs can also contain a portion of base gas or cushion gas that can mostly remain in the reservoirs during operation of the system. The cushion gas can provide the required pressurization to extract natural gas and liquids out of the low-pressure subterranean reservoir.

The high-pressure and the low-pressure subterranean reservoirs 4 and 6 can be substantially close to each other in order to minimize piping length thus minimizing pressure drop. For example, the two reservoirs can be separated by 100 to 500 meters, although greater distances are possible. The high-pressure and the low-pressure subterranean reservoirs 4 and 6 can be separated by a distance greater than 1 kilometer and up to 50 km for example. Greater distances can lead to higher pressure-drop and energy losses and thus the distance can be selected to be within an acceptable range of pressure-drop for the process design.

The high-pressure subterranean reservoir 4 and/or the low-pressure subterranean reservoir 6 can include a depleted oil reservoir or a rich gas condensate reservoir comprising condensed hydrocarbons. In other implementations, the reservoirs can be dry gas reservoirs, where no phase changes occur. The high-pressure and the low-pressure subterranean reservoirs 4 and 6 should be selected to ensure proven containment with no major faults or fractures other than potentially small skin fractures. Containment can be confirmed with monitoring of leakages of natural gas at ground-level zones above the low-pressure subterranean reservoir 6 and the high-pressure subterranean reservoir 4 prior operation of the system 2 and during operation.

The low-pressure subterranean reservoir 6 and the high-pressure subterranean reservoir 4 can be both maintained at a temperature between 40° C. and 120° C. Depths of the low-pressure subterranean reservoir 6 and the high-pressure subterranean reservoir 4 can influence the temperature of these reservoirs. A reservoir located at a deeper underground level can be at a higher temperature than a reservoir located at a shallower level. The low-pressure subterranean reservoir 6 and the high-pressure subterranean reservoir 4 can be located at a same depth or different depths.

### Hydrocarbon Recovery Assembly Implementations

As described above, the high-pressure subterranean reservoir 4 and the low-pressure subterranean reservoir 6 can be depleted reservoirs which previously contained various types of hydrocarbons. Hydrocarbons can be an added-value product saleable on a relevant market. In some implementations, the high-pressure subterranean reservoir 4 and/or the low-pressure subterranean reservoir 6 can contain residual heavy hydrocarbons. Accordingly, a hydrocarbon recovery assembly 16 can be provided and configured to recover hydrocarbons from the natural gas retrieved from the low-pressure subterranean reservoir 6, from the natural gas retrieved from the high-pressure subterranean reservoir 4, or alternating operation from one to the other. In some implementations, recovery of the hydrocarbons can be achieved by exploiting the Joule-Thompson effect or by operating a shallow cut gas plant or a deep cut gas plant annexed to rest of the system. The shallow cut gas plant can include a simple refrigeration loop or a Joule-Thompson valve to knockout C5+ as a liquid stream and produce natural gas meeting pipelines requirements. The recovery of liquids is therefor not maximized in the shallow cut gas plant. On the other hand, the deep cut gas plant can include additional equipment and involve higher energy consumption compared with the shallow cut plant to increase liquid recovery yields. For example, C2+ can be recovered and separated from the natural gas when a deep cut gas plant is operated. The hydrocarbon recovery assembly 16 can be operated at surface as shown on the figures.

The hydrocarbon recovery assembly 16 can be configured to receive a hydrocarbon-containing natural gas feed stream withdrawn from the low-pressure subterranean reservoir 6 or withdrawn from the energy recovery assembly downstream 14 of the high-pressure subterranean reservoir 4. Therefore, the same hydrocarbon recovery assembly 16 can be used to recover hydrocarbons from the low-pressure subterranean reservoir 6 and from the natural gas retrieved from high-pressure subterranean reservoir 4. The hydrocarbon recovery assembly 16 can be configured to receive the hydrocarbon-containing natural gas feed stream and produce a single recovered liquid hydrocarbon stream or multiple recovered hydrocarbon streams depending on the quantity of hydrocarbons recovered. The multiple recovered hydrocarbon streams can be any variation of C2/C3/C4/C5+ and/or sales quality component streams of C2 and heavier hydrocarbons. Following recovery, a hydrocarbon-lean gas stream can be either sent to the natural gas compression assembly 12 or the low-pressure subterranean reservoir 6. In other implementations, the natural gas can also be treated to recover hydrocarbons when said natural gas is ready to be withdrawn from the system to be sold and supplied back into sales line.

For operation of the hydrocarbon recovery assembly 16, a pressure-regulating valve or any pressure regulator can be added upstream of the assembly 16 so that the pressure remains substantially the same whether the hydrocarbon-containing natural gas feed stream comes from the high-pressure subterranean reservoir 4, the low-pressure subterranean reservoir 6.

The hydrocarbon recovery assembly 16 can include various separators and equipment depending on process design and properties of the input feed stream. One example of the hydrocarbon recovery assembly 16 configuration is described in further detail below.

Referring to FIG. 3, the hydrocarbon recovery assembly 16 can comprise a chiller 31 configured to lower a temperature of the hydrocarbon-containing natural gas feed stream, followed by a separator 32 performing a first separation allowing the production of a gas overhead stream 38 and a liquid stream 36. The chiller 31 can be configured to lower the temperature of the hydrocarbon-containing natural gas feed stream to a temperature between 0° C. and 90° C. for example. A turboexpander or a Joule-Thompson valve can alternatively be used to lower the temperature of the feed stream. The first separation can be a condensation separation performed in a condensation vessel, allowing the hydrocarbon-containing natural gas feed stream to reach a hydrocarbon dew point and therefore condense. The condensation vessel can also be referred to as a liquid knock-out vessel, a free liquid separator, a cold separator, or a low temperature separator. The liquid stream can mostly comprise hydrocarbons selected from the group consisting of C2, C3, C4 and C5+, a water component (comprising brine or salty water) and other nonhydrocarbon impurities.

Referring to FIGS. 2 and 3 the hydrocarbon recovery unit 16 can further comprise a separation unit 34 configured to receive the liquid stream 36 and perform a second separation to produce an upper gas stream 40 and a bottom liquid stream 44. The separation unit 34 can comprise at least one distillation column or any suitable equipment to carry out the separation. The distillation column can be configured and operated to produce only two output streams, or additional output streams that can include different hydrocarbon cuts.

In other implementations, the separation unit 34 can further separate the bottom liquid stream 44 into different cuts that can be sold separately. The separation unit 34 can include several towers such as a de-methanizer, a de-ethanizer, a de-propanizer, a debutanizer or a stabilizer. The stabilizer can be used when separation of C5+ is desired. Accordingly, the bottom liquid stream 44 can undergo a flash separation producing a C2 to C4 hydrocarbon gas stream and a C5+ hydrocarbon liquid stream. Alternatively, the bottom liquid stream 44 can be sold as a single product.

In some implementations, a heat exchanger 31 can be added upstream of the hydrocarbon recovery assembly to heat, e.g., by indirect heat exchange, the gas overhead stream 38 with heat released by the hydrocarbon-containing natural gas feed stream. In other implementations, the gas overhead stream 38 can be heated with the thermal energy recovered by the at least one cooler 48 located downstream of each compression stage 46 in the natural gas compression assembly 12.

Referring to FIGS. 2 and 3, the gas overhead stream 38 and the upper gas stream 40 can be merged via a piping assembly to form a combined natural gas stream 42. As mentioned above, the hydrocarbon-containing natural gas feed stream can be provided from the low-pressure subterranean reservoir 6 or the energy recovery assembly 14, for example. When the hydrocarbon-containing natural gas feed stream is provided from the low-pressure subterranean reservoir 6, the natural gas compression assembly 12 can be in fluid communication with the piping assembly to receive the combined natural gas stream 42. Accordingly, the combined natural gas stream 42 can be compressed to become the high-pressure natural gas 8 and be ultimately injected into the high-pressure subterranean reservoir 4. Alternatively, when the hydrocarbon-containing natural gas feed stream is provided from the natural gas compression assembly 12, the low-pressure subterranean reservoir 6 can be in fluid communication with the piping assembly to receive the combined natural gas stream 42. Therefore, the combined natural gas stream 42 can become the low-pressure natural gas 10.

Now referring to FIG. 5, in addition to the separation unit 34 described above, the hydrocarbon recovery system 16 can comprise an additional separation unit 50 configured to receive the gas overhead stream 38 and produce an additional overhead stream 52 and an additional liquid stream 54. The gas overhead stream 38 can be sent to an overhead expander to produce an expanded stream that can then be injected into the additional separation unit 50. The overhead expander can include a turbine or any suitable valve, for example. The additional liquid stream 54 produced by the additional recovery separation unit 50 can be combined with the liquid stream 36 produced by the separator 32 via a piping arrangement to form a combined liquid stream 56. The separation unit 34 can be in fluid communication with said piping arrangement to receive the combined liquid stream 56 and perform another separation. Therefore, the additional separation unit 50 can be located downstream of the separator 32 and upstream of the separation unit 34. A piping assembly can be configured to merge the upper gas stream 40 of the separation unit 34 with the additional overhead stream 52 of the additional separation unit 50 to form a combined natural gas stream 58. When the hydrocarbon-containing natural gas feed stream is provided by the low-pressure subterranean reservoir 6, the natural gas compression assembly 12 can be in fluid communication with the piping assembly to receive the combined natural gas stream 58. Alternatively, when the hydrocarbon-containing natural gas feed stream is provided by the energy recovery assembly 14, the low-pressure subterranean reservoir 6 can be in fluid communication with the piping assembly to receive the combined natural gas stream 58. The additional separation unit 50 can include a distillation column and more precisely, a de-methanizer in order to separate, for example, methane from rest of the hydrocarbons.

It is noted that depending on a determined yield of hydrocarbon recovery, the hydrocarbon recovery assembly 16 can comprise one or more separation assemblies to remove hydrocarbons from the natural gas. The corresponding separation assemblies can further comprise a multitude of separation units, still depending on the yield of hydrocarbon recovery and according to the purity of the hydrocarbon-lean gas stream obtained. The multitude of separation units can comprise at least one flash unit and at least one distillation unit to perform the recovery. The purity of the hydrocarbon-lean gas stream can be determined on pipeline requirements of the area where the system is implanted. Depending on a volume of gas to be treated, more or less hydrocarbons can be recovered in order for the at least one gas expander 24 of the energy recovery assembly 14 to run efficiently with a suitable gas flow.

Recovered hydrocarbons, natural gas liquids, condensate, oils streams and other streams exiting the system can be stored in separate holding tanks until further handling, sale, or processing.

Referring to FIG. 1, the system can also include a control unit coupled to equipment and lines as needed for controlling various parameters of the system including the flow direction during surplus and deficit periods. The control unit can be coupled to valves to open and close the proper lines to enable the desired flow direction. The control unit can be integrated into many parts of the process to control parameters such as pressures, temperatures, flow rates, etc., and can conduct the control based on input information that can be obtained from monitoring systems and instrumentation that is present in the system and from sources of energy demand information.

In another implementation of the system that includes hydrocarbon recovery, natural gas can be transferred between a pipeline and a high-pressure reservoir without the use of a low-pressure reservoir. Such a system can thus comprise a high-pressure subterranean reservoir configured to receive and contain high-pressure natural gas, the high-pressure subterranean reservoir being a hydrocarbon-depleted subterranean reservoir; a natural gas compression assembly; an energy recovery assembly; and a hydrocarbon recovery assembly. The natural gas compression assembly can be configured to receive natural gas from a natural gas source such as a pipeline; compress the natural gas to form the high-pressure natural gas; and supply the high-pressure natural gas into the high-pressure subterranean reservoir, during surplus periods. The energy recovery assembly can be configured to receive at least a portion of the high-pressure natural gas from the high-pressure subterranean reservoir, expand the high-pressure natural gas to generate energy and produce low-pressure natural gas, and supply the low-pressure natural gas to the low-pressure natural gas source (e.g., pipeline), during deficit periods. Finally, the hydrocarbon recovery assembly can be configured to recover hydrocarbons and optionally non-hydrocarbon components from the low-pressure natural gas produced by the energy recovery assembly and produce a hydrocarbon-lean gas stream and a recovered hydrocarbon stream. The system can further comprise a return line configured to supply the hydrocarbon-lean gas stream back to the natural gas source. The recovered hydrocarbon stream can be composed of any variation of C2, C3, C4 or C5+ and/or sales quality component streams of C2 and heavier. The recovered hydrocarbon stream can undergo further separation steps to obtain streams of determined composition. The natural gas source can comprise a natural gas pipeline or a low-pressure subterranean reservoir, or another source of natural gas.

In some implementations, when selling prices of natural gas are low, the hydrocarbon recovery assembly can comprise a knock-out unit to separate C4+ hydrocarbons and other liquids from a gas stream containing natural gas, C2 and C3 hydrocarbons. The gas stream containing natural gas, C2 and C3 hydrocarbons can then be reintroduced into the natural gas compression assembly and the C4+ hydrocarbons and other liquids withdrawn from the system 2.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present implementations and examples, therefore, are to be considered in all respects as illustrative and not restrictive, and the technology is not to be limited to the details given herein. Accordingly, while the specific implementations have been illustrated and described, numerous modifications come to mind.

1. A natural gas energy storage system, comprising:
a high-pressure subterranean reservoir configured to receive and contain high-pressure natural gas, the high-pressure subterranean reservoir being a first hydrocarbon-depleted subterranean reservoir;
a low-pressure subterranean reservoir configured to receive and contain low-pressure natural gas, the low-pressure subterranean reservoir being a second hydrocarbon-depleted subterranean reservoir;
a natural gas compression assembly configured to receive natural gas from the low-pressure subterranean reservoir, compress the natural gas to form the high-pressure natural gas, and supply the high-pressure natural gas into the high-pressure subterranean reservoir, during surplus periods; and
an energy recovery assembly configured to receive at least a portion of the high-pressure natural gas from the high-pressure subterranean reservoir, expand the high-pressure natural gas to generate energy and produce the low-pressure natural gas, and supply the low-pressure natural gas into the low-pressure subterranean reservoir, during deficit periods.

2. The natural gas energy storage system of claim 1, wherein the natural gas compression assembly comprises at least one compression stage configured to compress natural gas to form the high-pressure natural gas and inject the same into the high-pressure subterranean reservoir.

3. The natural gas energy storage system of claim 1, further comprising a gas-liquid separator located upstream of the energy recovery assembly and configured to separate free liquids from the high-pressure natural gas.

4. The natural gas energy storage system of claim 1, wherein the energy recovery assembly comprises at least one gas expander and at least one generator configured to generate electricity when the high-pressure natural gas passes there through.

5. The natural gas energy storage system of claim 4, further comprising a least one power storage battery configured to collect the electricity generated by the energy recovery assembly.

6. The natural gas energy storage system of claim 1, further comprising a hydrocarbon recovery assembly configured to recover hydrocarbons from the natural gas retrieved from the low-pressure subterranean reservoir, from the natural gas retrieved from high-pressure subterranean reservoir, or alternating operation from one to the other.

7. The natural gas energy storage system of claim 6, wherein the hydrocarbon recovery assembly is configured to receive a hydrocarbon-containing natural gas feed stream withdrawn from the low-pressure subterranean reservoir or withdrawn from the energy recovery assembly downstream the high-pressure subterranean reservoir and produce at least one recovered liquid hydrocarbon-containing natural gas feed stream and a natural gas stream.

8. A process of storing energy and natural gas, the process comprising:
a compression stage operated during surplus periods, the compression stage comprising:
recovering low-pressure natural gas from a low-pressure subterranean reservoir;
compressing natural gas at surface to produce a high-pressure natural gas;
supplying the high-pressure natural gas into a first hydrocarbon-depleted subterranean reservoir as a high-pressure subterranean reservoir;
an energy recovery stage operated during deficit periods, the energy recovery stage comprising:
recovering at least a portion of the high-pressure natural gas from the high-pressure subterranean reservoir;
expanding the high-pressure natural gas at surface to generate energy and low-pressure natural gas; and
supplying the low-pressure natural gas into a second hydrocarbon-depleted subterranean reservoir as the low-pressure subterranean reservoir.

9. The process of claim 8, wherein compressing the natural gas comprises at least one compression stage and at least one cooling step downstream of each of the at least one compression stage.

10. The process of claim 8, wherein expanding the high-pressure natural gas is performed using at least one gas expander-and-generator assembly and at least one heat exchanger to form the low-pressure natural gas and to generate electricity.

11. The process of claim 8, further comprising recovering hydrocarbons from the low-pressure natural gas at surface, wherein the recovering of the hydrocarbons comprises subjecting the natural gas to a first separation stage to produce a gas overhead stream and a liquid stream, subjecting the liquid stream to a second separation stage to produce an upper gas stream and a bottom liquid stream, and combining the upper gas stream and the gas overhead stream to produce a combined natural gas stream.

12. The process of claim 11, wherein the recovering of the hydrocarbons comprises subjecting the natural gas to a first separation stage to produce a gas overhead stream and a liquid stream, subjecting the gas overhead stream to an additional separation stage to produce an additional overhead stream and an additional liquid stream, combining the additional liquid stream with the liquid stream to produce a combined liquid stream, subjecting the combined liquid stream to a second separation stage to produce an upper gas stream and a bottom liquid stream, and combining the upper gas stream and the additional overhead stream to produce a combined natural gas stream.

13. The process of claim 11, wherein, during the compression stage, the combined natural gas stream is supplied as the natural gas for compression at surface to produce the high-pressure natural gas.

14. The process of claim 11, wherein, during the energy recovery stage, the combined natural gas stream is supplied as the low-pressure natural gas to the low-pressure subterranean reservoir.

15. The process of claim 8, wherein the high-pressure subterranean reservoir and the low-pressure subterranean reservoir are mature hydrocarbon-depleted subterranean reservoirs used for recovery of natural gas liquids, oil, or a combination thereof.

16. A natural gas energy storage system, comprising:
a high-pressure subterranean reservoir configured to receive and contain high-pressure natural gas, the high-pressure subterranean reservoir being a hydrocarbon-depleted subterranean reservoir;
a natural gas compression assembly configured to receive natural gas from a natural gas source, compress the natural gas to form the high-pressure natural gas, and supply the high-pressure natural gas into the high-pressure subterranean reservoir, during surplus periods;
an energy recovery assembly configured to receive at least a portion of the high-pressure natural gas from the high-pressure subterranean reservoir, expand the high-pressure natural gas to generate energy and produce low-pressure natural gas, and supply the low-pressure natural gas to the low-pressure natural gas source, during deficit periods;
a hydrocarbon recovery assembly configured to recover at least C4+ hydrocarbons and/or non-hydrocarbon components from the low-pressure natural gas produced by the energy recovery assembly and produce a hydrocarbon-lean gas stream and a recovered hydrocarbon stream; and
a return line configured to supply the hydrocarbon-lean gas stream back to the natural gas source.

17. The natural gas energy storage system of claim 16, wherein the hydrocarbon recovery assembly is configured to produce a hydrocarbon lean gas stream comprising C2 and C3 hydrocarbons.

18. The natural gas energy storage system of claim 17, wherein the natural gas compression assembly is configured to receive the hydrocarbon lean gas stream comprising C2 and C3 hydrocarbons to produce the high-pressure natural gas.

19. The natural gas energy storage system of claim 16, wherein the natural gas source comprises a natural gas pipeline.

20. The natural gas energy storage system of claim 16, wherein the natural gas source comprises a low-pressure subterranean reservoir.
